(19) United States
(12) Patent Application Publication
(10) Pub. No.: US 2023/0181400 A1
(43) Pub. Date: Jun. 15, 2023

(54) NEGATIVE-PRESSURE SHIELD DEVICE

(71) Applicant: MEDICAL TRANSPORT INC., Osaka (JP)

(72) Inventor: Tetsuo MATSUSHIMA, Osaka (JP)

(21) Appl. No.: 17/999,049

(22) PCT Filed: May 13, 2021
(86) PCT No.: PCT/JP2021/018198

§ 371 Date: Nov. 17, 2022

(30) Foreign Application Priority Data
May 21, 2019 (JP) 2020-088743
Aug. 1, 2020 (JP) 2020-131295

(51) Int. Cl. A61G 10/02; A61G 3/00; A61G 10/00

(52) U.S. Cl. CPC A61G 10/02; A61G 3/008; A61G 10/005

(57) ABSTRACT

The present invention provides a negative-pressure shield device with a simple device structure, which is relatively inexpensive to manufacture, and is extremely effective in preventing infection within an ambulance. The negative-pressure shield device comprises a shield main body that is installed in a patient compartment of an ambulance, includes a ceiling part and a peripheral wall part, and covers at least the head of a patient on a stretcher mounted in the patient compartment, and a connection part which communicates with the interior of the shield main body and connects to a ventilation opening provided in the patient compartment.

### RELATED APPLICATIONS

The present application is a National Phase of International Application Number PCT/JP2021/018198 filed May 13, 2021, which claims the benefit of priority from Japanese Patent Application Nos. 2020-088743, filed on May 21, 2020 and 2020-131295, filed on Aug. 1, 2020.

### TECHNICAL FIELD

The present invention relates to a negative-pressure shield device that generates negative pressure inside the device.

### BACKGROUND ART

Recently, the COVID-19 virus has become a worldwide problem. A critical issue is how to reduce contact with infected persons. One important countermeasure is eliminating the risk of infection among ambulance crews (or in the case of an emergency vehicle carrying a doctor, the medical staff such as doctors and nurses) during transport of a possibly infected person by ambulance. As examples of countermeasures, a variety of negative-pressure shield devices integrated with a stretcher have been proposed (Patent Literature 1 to Patent Literature 3).

### CITATION LIST

### Patent Literature

Patent Literature 1: JP 2004351123 A
Patent Literature 2: JP 2005028058 A
Patent Literature 3: JPH 11290383 A

### SUMMARY OF INVENTION

### Technical Problem

However, the above mentioned negative-pressure shield devices are expensive and have complicated structures. These problems have prevented widespread use of this type of negative-pressure shield device.

In view of the above-mentioned problems, the present invention has the object of providing a negative-pressure shield device that is relatively inexpensive to manufacture, has a simple device structure, and is extremely effective in preventing infection within an ambulance.

### Solution to Problem

The negative-pressure shield device according to the present invention includes

a shield main body that is installed within a patient compartment in an ambulance, includes a ceiling part and a peripheral wall part, and covers at least the head of a patient on a stretcher mounted in the patient compartment, and

a connection part that communicates with the interior of the shield main body and connects to a ventilation opening provided in the patient compartment.

An aspect of the negative-pressure shield device according to the present invention may employ a structure that includes:

the ceiling part including an engagement portion along the front-to-rear direction in the patient compartment, and

the shield main body being suspended and supported in the patient compartment with the engagement part directly or indirectly engaged with the upper part in the patient compartment.

In this case, the engagement part may employ a structure that includes:

a belt-like strip extending along the front-to-rear direction in the patient compartment and including a plurality of engagement holes at a predetermined spacing.

Further in this case, a structure may be employed that includes:

the shield main body being suspended and supported in the patient compartment with the engagement holes and a handrail provided on the upper part in the patient compartment, connected to each other with a connection means.

Another aspect of the negative-pressure shield device according to the present invention may employ a structure that includes:

the connection part having a cylindrical shape with one open end that covers an opening provided on the shield main body, and the other open end that covers the ventilation opening.

Further in this case, a structure may be employed that includes:

the connection part having flexibility, and the position and the direction of the other open end being adjustable within a predetermined range.

Another aspect of the negative-pressure shield device according to the present invention may employ a structure that includes,

the shield main body being formed in a size to accommodate the stretcher and a stretcher stand.

Further in this case, a structure may be employed that includes:

the shield main body including a carry-in/carry-out port that is opened/closed along an opening/closing line and is provided on the rear door side of the patient compartment of the peripheral wall part.

Another aspect of the negative-pressure shield device according to the present invention may employ a structure that includes:

at least the peripheral wall part that is composed of a flexible sheet.

Still another aspect of the negative-pressure shield device according to the present invention may employ a structure that includes:

the shield main body that is configured to be expandable into a flat state.

Still another aspect of the negative-pressure shield device according to the present invention may employ a structure that includes:

the shield main body that includes an air intake.

Still another aspect of the negative-pressure shield device according to the present invention may employ a structure that includes:

another connection part that communicates with the interior of the shield main body and connects to an ozone gas-generating apparatus installed in the patient compartment.

### Advantageous Effects of Invention

As described above, the negative-pressure shield device with a simple device structure that is relatively inexpensive to manufacture and is also extremely effective in preventing infection in an ambulance can be obtained according to the present invention.

### BRIEF DESCRIPTION OF DRAWINGS

FIG. 1 is a perspective view of the interior of the patient compartment in an ambulance where a negative-pressure shield device of a first embodiment of the present invention is installed, as seen from the rear door side.

FIG. 2 is a perspective view of the interior of the same patient compartment in the ambulance as seen from the driver's seat side.

FIG. 3A is a front view of the same negative-pressure shield device. FIG. 3B is a side view of the same negative-pressure shield device.

FIG. 4A is a front cross-sectional view of the same negative-pressure shield device.

FIG. 4B is a side cross-sectional view of the same negative-pressure shield device.

FIG. 5A is a plan view of the same negative-pressure shield device in an expanded state.

FIG. 6A is a front view of a negative-pressure shield device of a second embodiment of the present invention, and FIG. 6B is a side view of the same negative-pressure shield device.

FIG. 7A is a front cross-sectional view of the same negative-pressure shield device.

FIG. 7B is a side cross-sectional view of the same negative-pressure shield device.

FIG. 8A is a plan view of the same negative-pressure shield device in an expanded state.

FIG. 9A is a front view of a negative-pressure shield device of another embodiment.

FIG. 9B is a side cross-sectional view of the same negative-pressure shield device.

FIG. 10A is a front cross-sectional view of a negative-pressure shield device of still another embodiment. FIG. 10B is a side cross-sectional view of the same negative-pressure shield device.

### DESCRIPTION OF EMBODIMENTS

### First Embodiment

A negative-pressure shield device of a first embodiment of the present invention is hereinafter described with reference to the drawings. The negative-pressure shield device of the first embodiment is the negative-pressure shield device installed within the “Tri-Heart” ambulance manufactured by Sapporo Body Manufacturing Co., Ltd.

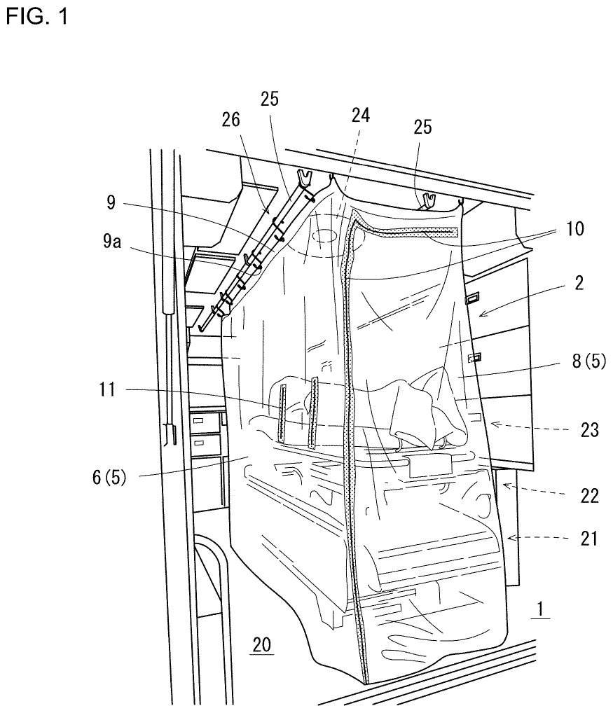

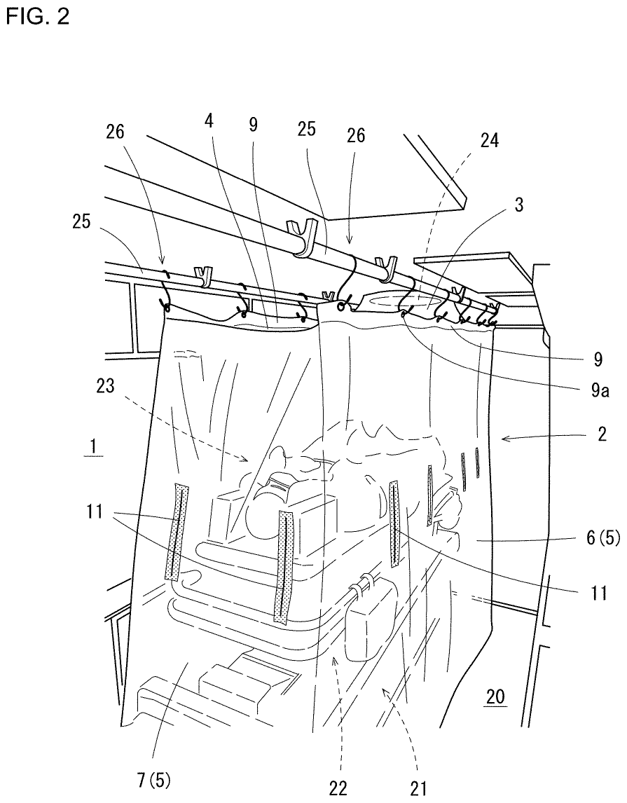

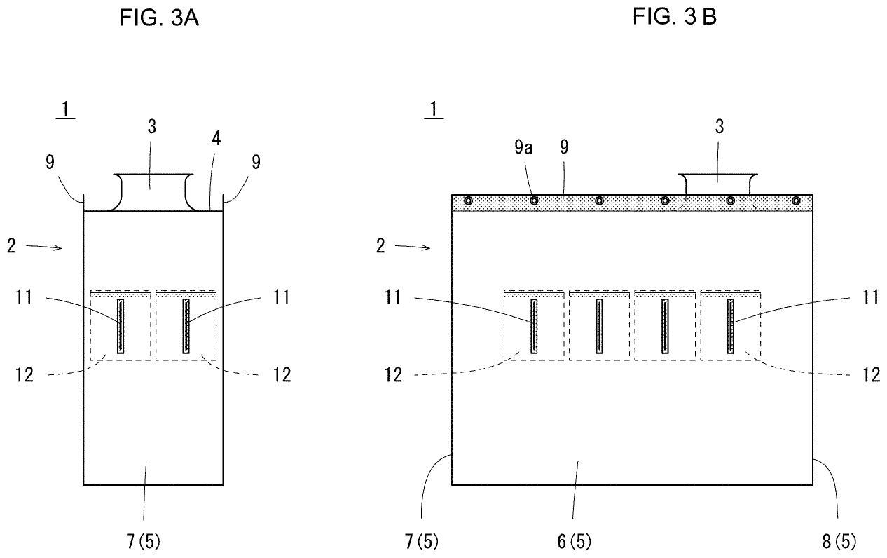

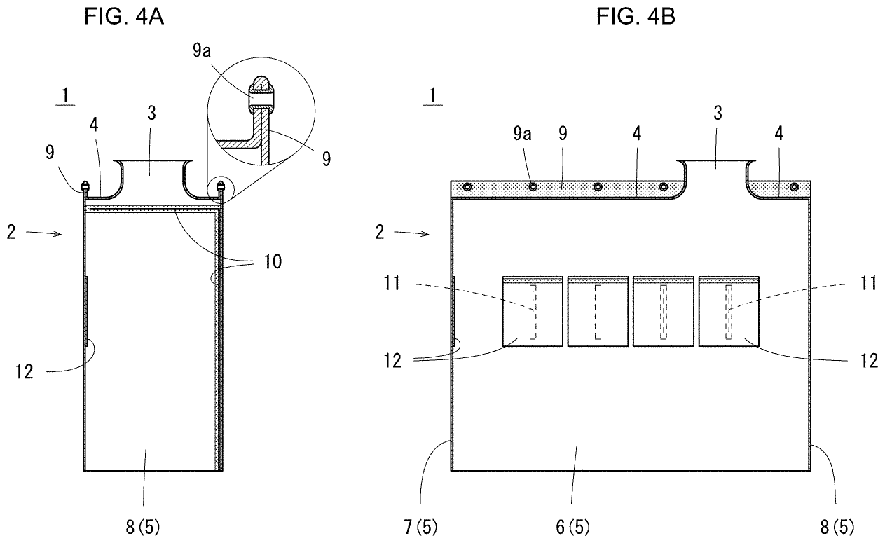

As shown in FIGS. 1 to 4, a negative-pressure shield device 1 includes a shield main body 2 and a connection part 3. The shield main body 2 is installed in a patient compartment 20 of the ambulance, covering a patient 23 on a stretcher 22 mounted on a stretcher stand 21 in the patient compartment 20. The connection part 3 communicates with the interior of the shield main body 2 and connects to a ventilation opening 24 formed in the upper part in the patient compartment 20.

The shield main body 2 includes a ceiling part 4 and a peripheral wall part 5. The ceiling part 4 and the peripheral wall part 5 are each composed of a flexible and transparent sheet. According to the present embodiment, the ceiling part 4 and the peripheral wall part 5 are composed of a vinyl sheet with a certain extent of thickness and strength that prevents the vinyl sheet from easily tearing.

The ceiling part 4 has a shape corresponding to the plan-view shape of the stretcher stand 21. In the present embodiment, the ceiling part 4 has a rectangular shape. The ceiling part 4 is disposed in a position close to the ceiling of the patient compartment 20.

The peripheral wall part 5 includes a side wall portion 6, a front wall portion 7, and a rear wall portion 8. The side wall portion 6 is positioned along the side walls of the patient compartment 20. The front wall portion 7 is positioned on the side of the driver's seat in the ambulance. The rear wall portion 8 is positioned on the rear door side of the patient compartment 20. The width of the side wall portion 6 corresponds to the length in the front-to-rear direction of the stretcher stand 21. The widths of the front wall portion 7 and the rear wall portion 8 each correspond to the width of the stretcher stand 21. The side wall portion 6, the front wall portion 7, and the rear wall portion 8 hanging down from the sides of the ceiling part 4 each have a length that is in contact with or in proximity to a floor surface of the patient compartment 20.

The shield main body 2 therefore has a longitudinal box shape with the opened lower part, accommodating the stretcher stand 21, the stretcher 22, and the patient 23 in the interior and covering the entire body of the patient 23.

The stretcher stand 21 is movable in the direction of the vehicle width. However, the shield main body 2 has an ample length in the vertical direction. For this reason, wherever it is positioned, the stretcher 21 is always maintained in a state accommodated within the shield main body 2 without protruding therefrom.

Due to the height dimensions of the stretcher stand 21 and the stretcher 22, the patient 23 is positioned at a height position which corresponds to approximately half of the height dimension of the patient compartment 20. The patient 23 is therefore sufficiently separated away from the ceiling part 4 of the shield main body 2. The patient 23 can therefore sit up within the space inside the shield main body 2 (isolation compartment).

The connection part 3 having a square tube shape or a cylindrical shape serves as an air intake duct. An opening is formed on the ceiling part 4. One open end of the connection part 3 is attached so as to cover (enclose) the opening. The connection part 3 is a flexible and transparent sheet in a cylindrical shape. According to the present embodiment, the connection part 3 is composed of a vinyl sheet with a certain extent of thickness and strength that prevents the vinyl sheet from easily tearing as with the shield main body 2. The connection part 3 therefore has flexibility and the position and direction of the other open end can be freely adjusted within a predetermined range. The ventilation opening 24 is formed on the ceiling of the patient compartment 20 immediately above the opening. The other open end of the connection part 3 is attached so as to cover (enclose) the ventilation opening 24. The connection part 3 is attached to the ceiling of the patient compartment 20 around the ventilation opening 24 by using various known means such as a tape, a hook-and-loop fastener, and an adhesive.

When a ventilator is turned on, the air inside the shield main body 2 is suctioned from the ventilation opening 24 through the inside of the connection part 3. This suction changes the interior atmosphere of the shield main body 2 into a negative-pressure atmosphere. The air exhaled by the patient 23 will consequently not leak out from the shield main body 2 and all of the exhaled air is exhausted from the patient compartment 20 through the connection part 3 and the ventilation opening 24. The risk of infecting the ambulance crew members in the driver seat or in the patient compartment 20 (or in the case of an emergency vehicle carrying a doctor, the medical staff such as doctors and nurses) can therefore be eliminated.

The ceiling part 4 includes an engagement portion 9 along the front-to-rear direction in the patient compartment 20. In further detail, the ceiling part 4 comprises a symmetrical pair of engagement portions 9, 9 along each side edge. The spacing between the pair of engagement portions 9, 9 therefore corresponds to the width of the stretcher stand 21. The engagement portion 9 is a section in which the side edge of the sheet of the ceiling part 4 and the upper edge of the sheet of the side wall portion 6 are joined (for example heat-sealed) over a predetermined width. The engagement portion 9 is therefore a belt-like strip that extends along the front-to-rear direction in the patient compartment 20 and is reinforced to be thicker than the other sheets.

The engagement portion 9 has a plurality of engagement holes 9a, . . . at a predetermined spacing. In the present embodiment, the engagement hole 9a is a hole reinforced with a grommet attached to the belt-like strip.

On the ceiling of the patient compartment 20, a pair of handrails 25, 25 being in parallel at an interval and extending in the front-to-rear direction in the patient compartment 20 are provided. The interval between the pair of handrails 25, 25 corresponds to the width of the stretcher stand 21. One end of an S-shaped hook 26 is hooked into the engagement hole 9a of the engagement portion 9 and the other end of the S-shaped hook 26 is hooked on the handrail 25. The shield main body 2 is therefore suspended and supported in the patient compartment 20, maintaining the box shape.

The shield main body 2 includes a carry-in/carry-out port in the rear wall portion 8. In the present embodiment, a fastener-based opening/closing line 10 for example is provided along the orthogonal two sides of the upper and side edges of the rear wall portion 8. By opening the opening/closing line 10, the carry-in/carry-out port is opened and the stretcher 22 can be carried in or out. By closing the opening/closing line 10, the carry-in/carry-out port is closed and the shield main body 2 can be sealed.

The shield main body 2 includes a plurality of arm insertion openings at appropriate positions. For example, a pair of arm insertion openings is provided on the front wall portion 7-side of the side wall portion 6 to access the upper body of the patient 23. Another pair of arm insertion openings is provided on the rear wall portion 8-side of the side wall portion 6 to access the lower body of the patient 23. Still another pair of arm insertion openings is provided on the front wall portion 7 to access the head or face of the patient 23. A fastener-based opening/closing line 11 is for example provided in the present embodiment. By opening the opening/closing line 11, the arm insertion opening is opened, and an arm can be inserted inside the shield main body 2. In order to prevent the leakage of contaminated air (such as spray and droplets) from the interior of the shield main body 2 through the arm insertion opening, a shield 12 covering the opening/closing line 11 from the inside is provided. The shield 12 is composed of the same material as that of the shield main body 2, and the upper edge thereof is joined (for example heat-sealed) onto the shield main body 2.

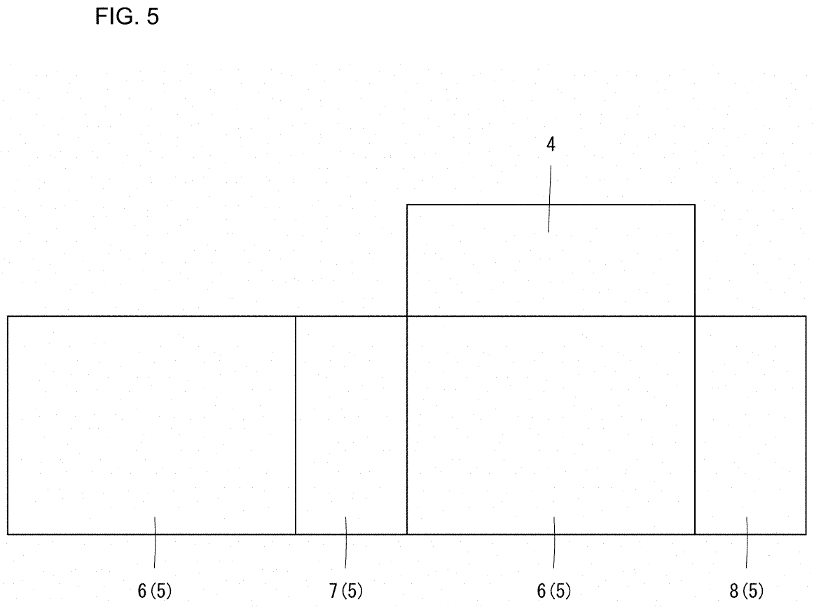

As shown in FIG. 5, the shield main body 2 is configured to be expandable into a flat state by cutting off an appropriate side of the ceiling part 4, the side wall portion 6, the front wall portion 7, and the rear wall portion 8. Specifically, the shield main body 2 is expandable into a flat state by providing an appropriate fastener-based opening/closing line such as the fastener-based opening/closing line 10.

In this way, the negative-pressure shield device 1 of the present embodiment can apply negative pressure exclusively to the patient-dedicated zone (the area above the stretcher 22) which is a part of the space in the patient compartment 20. The risk of infecting other persons in the ambulance is therefore eliminated, and infectious substances can be appropriately prevented from dispersing and adhering onto objects such as medical equipment installed within the patient compartment 20, and secondary infection can be effectively prevented.

The negative-pressure shield device 1 of the present embodiment can also enclose the patient 23 with the peripheral wall part 5 of the shield main body 2. The shield main body 2, due to the ceiling part 4 added to the structure thereof, can wrap around, cover, and enclose the patient 23. Scattering or dispersion from the upper part can therefore also be appropriately prevented.

The negative-pressure shield device 1 of the present embodiment can be installed simply by hooking the shield main body 2 onto the handrails 25, 25 provided in the upper part in the patient compartment 20 by using the S-shaped hooks 26 to allow easy attachment. The shield main body 2, in contrast, can be removed simply by removing the S-shaped hooks 26 to allow easy maintenance.

In the negative-pressure shield device 1 of the present embodiment, the shield main body 2 is transparent. The systemic conditions of the patient can therefore be visually observed.

In the negative-pressure shield device 1 of the present embodiment, the shield main body 2 can be expanded (disassembled) into a flat state. Therefore, during cleaning and disinfecting operations, the entire shield main body 2 can be washed with water (using a tool such as a deck brush) while spread out on the ground.

In the negative-pressure shield device 1 of the present embodiment, the patient 23 is sufficiently separated away from the ceiling part 4 of the shield main body 2. The negative-pressure shield device 1 of the present embodiment may therefore also be used for a patient who cannot assume a supine posture such as an asthma patient who is advised to maintain an upright upper body posture and a patient who needs to keep legs elevated. In other words, the negative-pressure shield device 1 of the present embodiment imparts an extremely high degree of body posture freedom to a patient.

### Second Embodiment

Next, a negative-pressure shield device of a second embodiment of the present invention is described with reference to the drawings. The negative-pressure shield device of the second embodiment is the negative pressure shield device installed in the “HIMEDIC” ambulance manufactured by Toyota Motor Corporation or the “PARAMEDIC” ambulance manufactured by Nissan Motor Corporation.

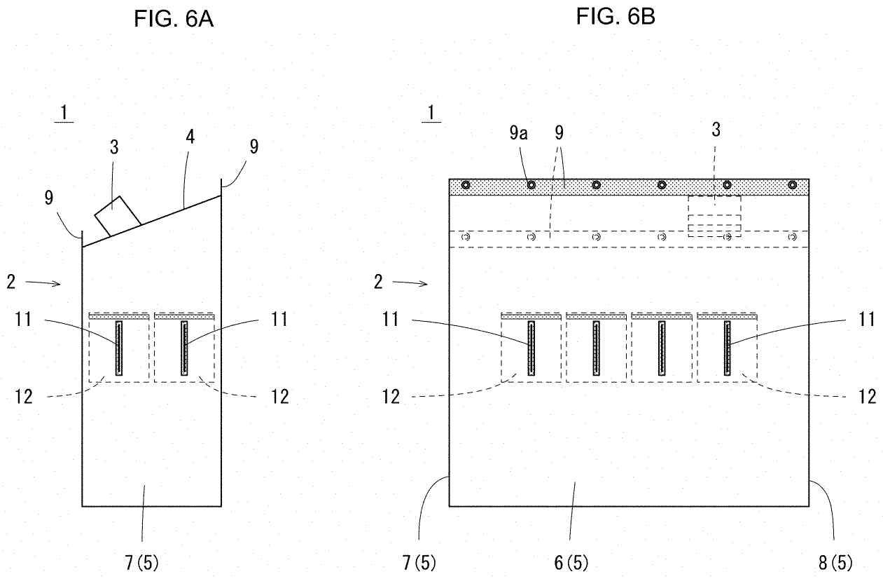

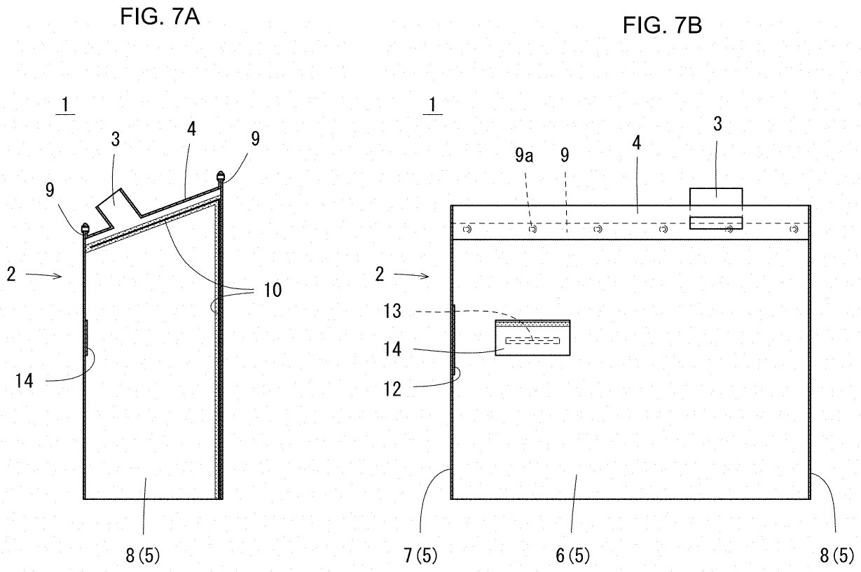

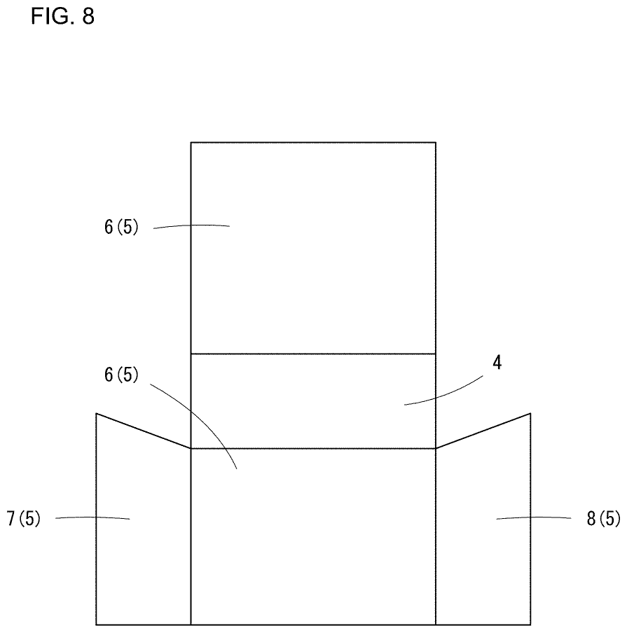

In the above types of ambulances, the stretcher stand 21 is mounted on the right half of the patient compartment 20 as seen from the rear side. The ceiling of the patient compartment 20 is not flat but curved, sloping downwards toward the side walls of the patient compartment 20. As shown in FIGS. 6A, 6B, 7A and 7B, the ceiling part 4 of the negative-pressure shield device 1 of the present embodiment therefore has a slope along the ceiling of the patient compartment 20.

Only one handrail is provided on the ceiling of the patient compartment 20. The engagement portion 9 at the higher level is hooked onto the handrail, and the engagement portion 9 at the lower level is hooked for example onto a handrail provided on the upper part of a side wall of the patient compartment 20.

In addition, there is no space for a person to enter between the side wall portion 6 facing the side wall of the patient compartment 20 and the side wall of the patient compartment 20. Therefore, no arm-insertion opening is provided on this side wall portion 6. Instead, as shown in FIGS. 7A and 7B, one or more similar structures (such as a fastener-based opening/closing line 13 and a shield 14) are provided. These structures are utilized as a lead-in inlet for taking in wires such as cords and cables for medical equipment installed (on a shelf) on the side wall of the patient compartment 20. In this case, the fastener must also be opened/closed from the interior of the shield main body 2. Due to these circumstances, a fastener having a slider pull on both the front and rear sides (what is called a double-sided slider fastener) is utilized as the fastener.

As described above, effects similar to those achieved by the negative-pressure shield device 1 of the first embodiment can also be achieved by the negative-pressure shield device 1 of the present embodiment.

The present invention is not limited to the above embodiments and various modifications may be made without deviating from the meaning and the scope of the present invention.

In the above embodiments, for example, the ceiling part 4 and the peripheral wall part 5 are configured to have a clear boundary. However, the present invention is not limited thereto. A physical boundary between the ceiling part and the peripheral wall part is also satisfactory even if it is not clearly defined.

In the above embodiments, the ceiling part 4 is composed of a vinyl sheet as with the peripheral wall part 5. However, the present invention is not limited to this arrangement. The ceiling part may be composed of a material different from the material of the peripheral wall and need not be transparent.

In the above embodiments, the shield main body 2 is composed of only a vinyl sheet and is maintained in an appropriate shape by utilizing the handrail 25. Items such as a frame are therefore not used. However, the present invention is not limited to this arrangement. Items such as a frame may also be used to obtain a shaping property to maintain the shield main body 2 in an appropriate shape.

In each of the above embodiments, the shield main body 2 has a cross-sectional shape to match the shape of the stretcher 22 and can therefore cover the entire body of the patient 23. However, the present invention is not limited thereto. The length of the shield main body may be shortened in the front-to-rear direction to cover just the upper body or just the head of the patient.

In each of the above embodiments, the shield main body 2 is engaged with the upper part in the patient compartment 20 by utilizing the S-shaped hooks 26. However, the present invention is not limited to this arrangement. Various known means such as string, tape, a magnet-type hook, or a hook-and-loop fastener may be utilized as a means to engage the shield main body with the upper part in the patient compartment.

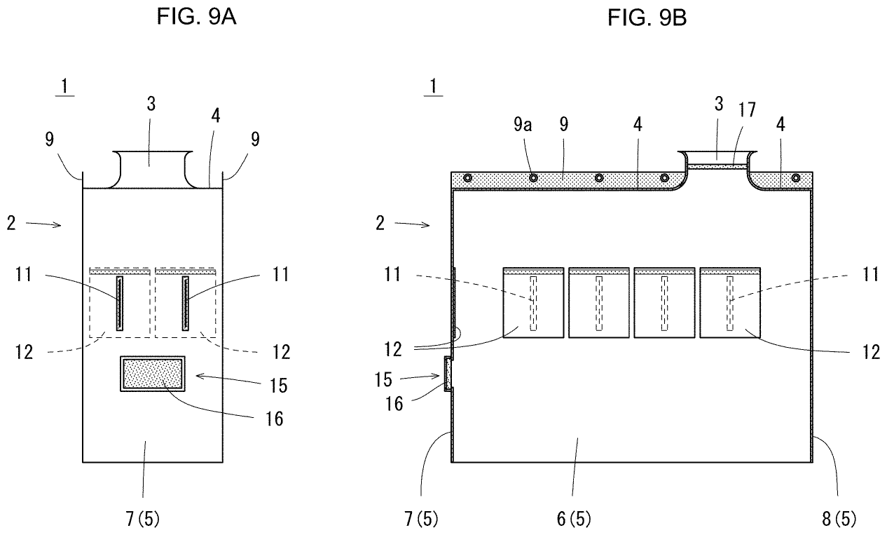

In each of the above embodiments, an air intake 15 may be provided as shown in FIGS. 9A and 9B. The air intake 15 is an opening formed in an appropriate position on the shield main body 2. The opening may be additionally provided with a high precision filter 16 such as a HEPA filter. Fresh air can in this way be taken into the interior of the shield main body 2. The air intake 15 is preferably provided on the peripheral wall part 5, in a position separated away from the connection part 3, for example on the front wall portion 7 or on the front wall portion 7-side in the side wall portion 6.

In each of the above embodiments, the connection part 3 may be provided with a high precision filter 17 such as a HEPA filter as shown in FIGS. 9A and 9B. Cleaned air can therefore be exhausted from the patient compartment 20.

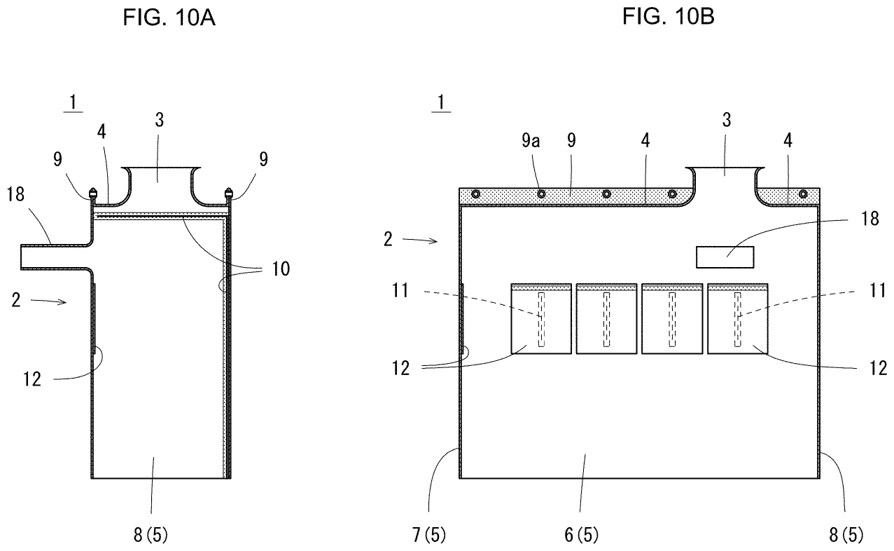

In each of the above embodiments, a second connection part 18 may be provided as shown in FIGS. 10A and 10B. The connection part 18 is connected to an ozone gas-generating apparatus installed in the patient compartment 20. In this way, only the interior of the shield main body 2 can be efficiently disinfected. The connection part 18 is a flexible and transparent sheet in a cylindrical shape. Except for details such as the size and shape, the connection part 18 has the same structure as that of the connection part 3. In the present embodiment, the connection part 18 is composed of a vinyl sheet with a certain extent of thickness and strength that prevents the vinyl sheet from easily tearing, as with the shield main body 2. The connection part 18 therefore has flexibility and the position and direction of the other open end can be freely adjusted within a predetermined range. The ozone gas-generating apparatus is usually installed (on a shelf) on the side wall of the patient compartment 20. The connection part 18 is in this case provided on the side wall portion 6.

In the above embodiments, the arm insertion opening is composed for example of a fastener-based opening/closing line 11. However, the present invention is not limited to this arrangement. Needless to say, diverse types of arm insertion openings such as common arm insertion openings in a circular shape as described in Patent Literature 1 and Patent Literature 2 are acceptable.

1. A negative-pressure shield device comprising:
a shield main body that is installed in a patient compartment of an ambulance, comprises a ceiling part and a peripheral wall part, and covers at least the head of a patient on a stretcher mounted in the patient compartment, and
a connection part that communicates with the interior of the shield main body and connects to a ventilation opening provided in the patient compartment.

2. The negative-pressure shield device according to claim 1, wherein the ceiling part includes an engagement portion along the front-to-rear direction in the patient compartment, and
the shield main body is suspended and supported in the patient compartment with the engagement portion directly or indirectly engaged with the upper part in the patient compartment.

3. The negative-pressure shield device according to claim 2, wherein the engagement portion is a belt-like strip extending along the front-to-rear direction in the patient compartment and includes a plurality of engagement holes at a predetermined spacing.

4. The negative-pressure shield device according to claim 3, wherein the shield main body is suspended and supported in the patient compartment with the engagement holes and a handrail provided on the upper part in the patient compartment, connected to each other by a connection means.

5. The negative-pressure shield device according to claim 1, wherein the connection part has a cylindrical shape with one open end covering an opening provided on the shield main body, and the other open end covering the ventilation opening.

6. The negative-pressure shield device according to claim 5, wherein the connection part has flexibility, and the position and the direction of the other open end can be adjusted within a predetermined range.

7. The negative-pressure shield device according to claim 1, wherein the shield main body is formed in a size to accommodate the stretcher and a stretcher stand.

8. The negative-pressure shield device according to claim 7, wherein the shield main body includes a carry-in/carry-out port that is opened/closed along an opening/closing line and is provided on the rear door side of the patient compartment of the peripheral wall part.

9. The negative-pressure shield device according to claim 1, wherein at least the peripheral wall part is composed of a flexible sheet.

10. The negative-pressure shield device according to claim 1, wherein the shield main body is configured to be expandable into a flat state.

11. The negative-pressure shield device according to claim 1, wherein the shield main body includes an air intake.

12. The negative-pressure shield device according to claim 1, comprising another connection part that communicates with the interior of the shield main body and connects to an ozone gas-generating apparatus installed in the patient compartment.
